(19) United States
(12) Patent Application Publication
(10) Pub. No.: US 2007/0290969 A1
(43) Pub. Date: Dec. 20, 2007

(54) OUTPUT BUFFER FOR GRAY-SCALE VOLTAGE SOURCE

(76) Inventor: Yih-Jen Hsu, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,076

(22) Filed: Jun. 16, 2006

(51) Int. Cl. G09G 3/36

(52) U.S. Cl. 345/89

(57) ABSTRACT

An output buffer for a gray-scale voltage source adapted to a flat panel display such as a liquid crystal display is provided. The gray-scale voltage source provides a reference voltage for converting digital data into corresponding gray-scale voltages. The output buffer comprises a differential amplifier, a power amplifier and a feedback network. The positive input terminal of the differential amplifier is coupled to the gray-scale voltage source. The negative input terminal of the differential amplifier is coupled to a second terminal of the feedback network. The output terminal of the differential amplifier is coupled to the input terminal of the power amplifier. The output terminal of the power amplifier is coupled to a first terminal of the feedback network. The output terminal of the power amplifier also outputs the voltage from the buffered gray scale voltage source to serve as the reference voltage.

### BACKGROUND OF THE INVENTION

1. Field of the Invention

The present invention relates to an output buffer. More particularly, the present invention relates to an output buffer for a gray-scale voltage source adapted to a flat panel display such as a liquid crystal display.

2. Description of the Related Art

In the field of a thin film transistor liquid crystal display (TFT-LCD), the gray-scale voltage source of a DC/DC circuit is normally designed to directly couple to provide gray-scale voltages. In which, the gray-scale voltage source provides a reference voltage for converting digital data into corresponding gray-scale voltages. Because the pixels must be driven by a driving method such as dot inversion, there is a transient change in the voltage outputted from the gray-scale voltage source between consecutive frames due to the loading on the display panel.

In general, the blanking time between consecutive frames must be utilized to return the voltage outputted from the gray-scale voltage source to a stable state. However, if the blanking time between the consecutive frames is not long enough for returning the voltage outputted from the gray-scale voltage source to a stable state, the transient change in the voltage may have some adverse effect on a previous or subsequent frame. For example, the brightness of the displayed frame may not be uniform.

FIG. 1 is a waveform diagram showing the voltage outputted from the gray-scale voltage source between consecutive frames. In which, the abscissa scale is 100 s/DIV and the ordinate scale is 200 mV/DIV. As shown in FIG. 1, the horizontal synchronous signal H_{syn} has an impulse train before the blanking time T_{blank}. The impulse train comprises a plurality of impulses. One of the impulses represents that one particular scan line is being enabled. Through data lines, gray-scale voltages of data corresponding to the particular scan line are delivered. Hence, one impulse train represents that one frame is being displayed.

For a liquid crystal display device having an 8-bit data driver and the liquid crystal driving voltage (that is, a reference voltage) of 4V, each gray scale differs by about 15 mV because there are 256 (=2⁸) gray scales altogether. As shown in FIG. 1, the pixel driving method will lead to a transient change (i.e. the circled block 103) in the voltage outputted from the gray-scale voltage source VDDA and the transient change is about 100 mV. Due to a short blanking time T_{blank} (or a long time needed when the transient change returns to a stable state), the transient change may affect gray-scale voltages of data corresponding to the last few data lines (i.e. the circled block 101) of the previous frame. In some case, even the first few data lines (i.e. the circled block 102) of the next frame are affected.

### SUMMARY OF THE INVENTION

Accordingly, at least one objective of the present invention is to provide an output buffer for a gray-scale voltage source adapted to a flat panel display such as a liquid crystal display. The output buffer is capable of reducing the transient change in the voltage outputted from the gray-scale voltage source between consecutive frames due to the load on the display panel so that the image display quality is improved.

To achieve these and other advantages and in accordance with the purpose of the invention, as embodied and broadly described herein, the invention provides an output buffer for a gray-scale voltage source adapted to a flat panel display such as a liquid crystal display. The gray-scale voltage source provides a reference voltage for converting digital data into corresponding gray-scale voltages. The output buffer comprises a differential amplifier, a power amplifier and a feedback network. The positive input terminal of the differential amplifier is coupled to the gray-scale voltage source. The negative input terminal of the differential amplifier is coupled to a second terminal of the feedback network. The output terminal of the differential amplifier is coupled to the input terminal of the power amplifier. The output terminal of the power amplifier is coupled to a first terminal of the feedback network and outputs the voltage from the buffered gray scale voltage source to serve as the reference voltage. In one embodiment, the differential amplifier is an operational amplifier, the power amplifier is a class-B amplifier or a class-B push-pull amplifier, and the feedback network is a conductive line or a resistor and a capacitor coupled in parallel between the output terminal of the power amplifier and the negative input terminal of the differential amplifier.

In one embodiment, the class-B push-pull amplifier includes a first type transistor and a second type transistor. A first terminal of the first type transistor is coupled to a firs voltage source and a second terminal of the first type transistor is coupled to a first terminal of the second type transistor and the output terminal of the class-B push-pull amplifier. A control terminal of the first type transistor is coupled to a control terminal of the second type transistor and the input terminal of the class-B push-pull amplifier. A second terminal of the second type transistor is coupled to a second voltage source. Here, the first type transistor can be an NPN bipolar junction transistor (BJT) and the second type transistor can be a PNP BJT. Alternatively, the first type transistor can be an N-type metal-oxide-semiconductor field-effect transistor (MOSFET) and the second type transistor can be a P-type MOSFET.

In the present invention, negative feedback is used to reduce the transient change in the voltage outputted from the gray-scale voltage source between consecutive frames due to the loading on the display panel. Hence, the overall image display quality is improved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a waveform diagram showing the voltage outputted from the gray-scale voltage source between consecutive frames.

FIG. 2 is a block diagram showing the components of an output buffer for a gray-scale voltage source according to one embodiment of the present invention.

FIG. 3 is a simulation graph showing the voltage outputted from a gray-scale voltage source without the output buffer shown in FIG. 2 and the voltage outputted from the gray-scale voltage source with the output buffer shown in FIG. 2.

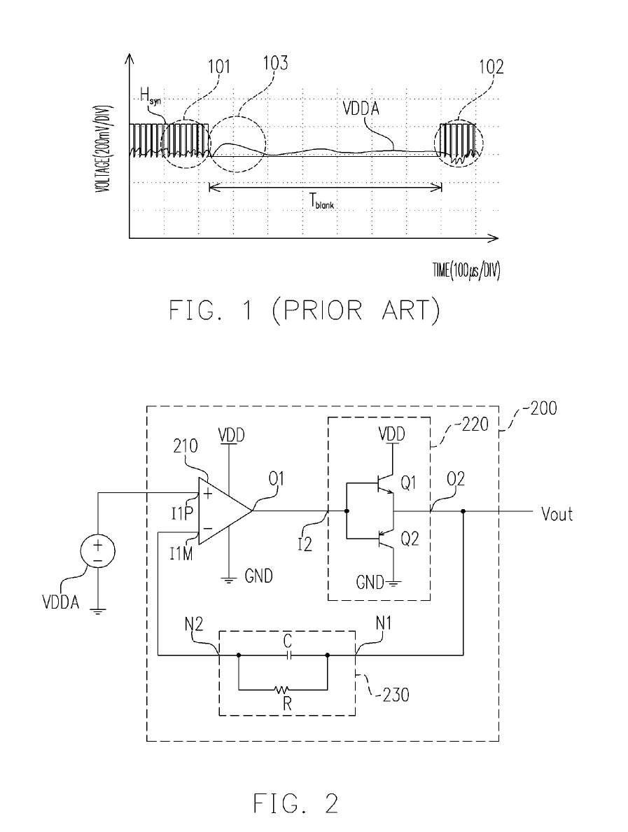

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

To simplify the following explanation, the differential amplifier is an operational amplifier, the power amplifier is a class-B push-pull amplifier (or “push-pull amplifier” in short), and the feedback network is a resistor and a capacitor coupled in parallel, for example. Furthermore, the first type transistor and the second type transistor are, for example, NPN bipolar junction transistor and PNP bipolar junction transistor respectively.

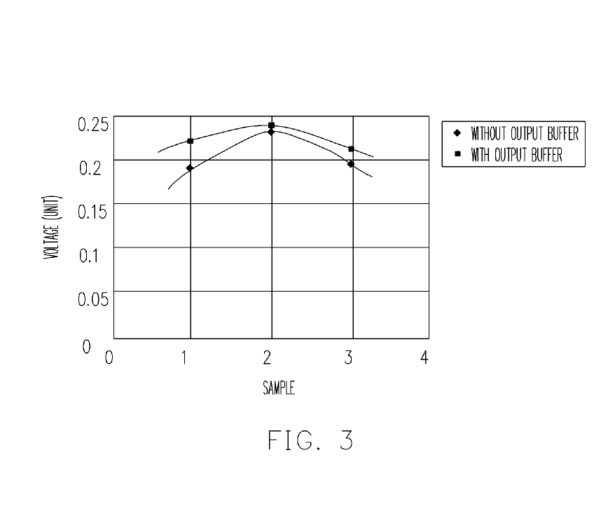

FIG. 2 is a block diagram showing the components of an output buffer for a gray-scale voltage source according to one embodiment of the present invention. As shown in FIG. 2, the output buffer 200 comprises an operational amplifier 210, a push-pull amplifier 220 and a feedback network 230. The positive input terminal I1P of the operational amplifier 210 is coupled to the gray-scale voltage source VDDA. The negative input terminal I1M of the operational amplifier 210 is coupled to a second terminal N2 of the feedback network 230. The output terminal O1 of the operational amplifier 210 is coupled to an input terminal 12 of the push-pull amplifier 220. Here, the gray-scale voltage source VDDA provides a reference voltage to a flat panel display (such as a liquid crystal display) in the process of converting digital data into corresponding gray-scale voltage. Furthermore, the output terminal O2 of the push-pull amplifier 220 is coupled to a first terminal N1 of the feedback network 230. The push-pull amplifier 220 also outputs a voltage Vₒᵤₜ outputted from the buffered gray-scale voltage source VDDA (i.e. the gray-scale voltage source VDDA is buffered by using the output buffer 200) to serve as a reference voltage.

The push-pull amplifier 220 includes an NPN transistor Q1 and a PNP transistor Q2. A first terminal (i.e. the collector) of the NPN transistor Q1 is coupled to a first voltage source VDD. A second terminal (i.e. the emitter) of the NPN transistor Q1 is coupled to a first terminal (i.e. the emitter) of the PNP transistor Q2 and the output terminal O2 of the push-pull amplifier 220. A control terminal (i.e. the base) of the NPN transistor Q1 is coupled to a control terminal (i.e. the base) of the PNP transistor Q2 and the input terminal 12 of the push-pull amplifier 220. A second terminal (i.e. the collector) of the PNP transistor Q2 is coupled to a second voltage source GND. The feedback network 230 includes a resistor R and a capacitor C coupled in parallel between the first terminal N1 and the second terminal N2.

FIG. 3 is a simulation graph showing the voltage outputted from a gray-scale voltage source without the output buffer 200 shown in FIG. 2 and the gray-scale voltage source with the output buffer 200 shown in FIG. 2. The graph is a simulation that targets the first few scan lines, the middle few scan lines and the last few scan lines of a frame and hence includes three samples. As shown in FIG. 3, the parameters used for obtaining the simulated results include the following: the voltage of a gray-scale voltage source VDDA of about 9.2V, a reference voltage Vout of about 4V, the frequency of a vertical synchronous signal of about 60 Hz, the frequency of a horizontal synchronous signal of about 64 kHz, and an output loading of about 200 μF. The reference voltage Vout of about 4V is obtained by suitably adjusting the first voltage source VDD and the second voltage source GND.

Furthermore, because the gray-scale voltage representing black color and the gray-scale voltage representing white color in the frame differs by about 1.4 units and the reference voltage Vout is 4V. Thus, each unit of the vertical coordinate in FIG. 3 represents the voltage of 3V. For a gray-scale voltage source without the output buffer, the voltage difference between the first and the second samples and the voltage difference between the second and the third samples are about 0.04 units (that is, 120 mV). By contrast, for the gray-scale voltage source with the output buffer, the voltage difference between the first and the second sample s and the voltage difference between the second and the third samples are about 0.018 unit (that is, 50 mV). It is apparent from the graph in FIG. 3 that the voltage outputted from the gray-scale voltage source is smoother and more stable when the output buffer is deployed. Hence, the transient change in the voltage outputted from the gray-scale voltage source due to the pixel driving method is significantly improved.

In summary, the differential amplifier, the power amplifier and the feedback network construct a negative feedback structure to reduce the transient change in the voltage outputted from the gray-scale voltage source between consecutive frames due to the loading on the display panel. As a result, the image display quality is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An output buffer for a gray-scale voltage source of a flat panel display, wherein the gray-scale voltage source provides a reference voltage for converting digital data into corresponding gray-scale voltages, the output buffer comprising:
a differential amplifier having a positive input terminal coupled to the gray-scale voltage source, a negative input terminal and an output terminal;
a power amplifier having an input terminal coupled to the output terminal of the differential amplifier and an output terminal for outputting a voltage from the buffered gray-scale voltage source to serve as the reference voltage; and
a feedback network having a first terminal coupled to the output terminal of the power amplifier and a second terminal coupled to the negative input terminal of the differential amplifier.

2. The output buffer according to claim 1, wherein the flat panel display is a liquid crystal display.

3. The output buffer according to claim 1, wherein the differential amplifier is an operational amplifier.

4. The output buffer according to claim 1, wherein the power amplifier is a class-B amplifier.

5. The output buffer according to claim 4, wherein the class-B amplifier is a class-B push-pull amplifier.

6. The output buffer according to claim 5, wherein the class-B push-pull amplifier comprises:
a first type transistor having a first terminal coupled to a first voltage source, a second terminal coupled to the output terminal of the class-B push-pull amplifier and a control terminal coupled to the input terminal of the class-B push-pull amplifier; and
a second type transistor having a first terminal coupled to the second terminal of the first type transistor and the input terminal of the class-B push-pull amplifier, a second terminal coupled to a second voltage source and a control terminal coupled to the input terminal of the class-B push-pull amplifier.

7. The output buffer according to claim 6, wherein the first type transistor is an NPN bipolar junction transistor and the second type transistor is a PNP type bipolar junction transistor.

8. The output buffer according to claim 6, wherein the first type transistor is an N-type metal-oxide-semiconductor field-effect transistor and the second type transistor is a P-type metal-oxide-semiconductor field-effect transistor.

9. The output buffer according to claim 1, wherein the feedback network is a conductive line.

10. The output buffer according to claim 1, wherein the feedback network comprises a resistor and a capacitor coupled in parallel between the output terminal of the power amplifier and the negative input terminal of the differential amplifier.
